(19) United States
(12) Patent Application Publication
(10) Pub. No.: US 2004/0221731 A1
(43) Pub. Date: Nov. 11, 2004

(54) Bread maker

(75) Inventors: Yong-hyun Kwon, Suwon-city (KR); Chul Kim, Anyang-city (KR); Tae-uk Lee, Suwon-city (KR); Han-jun Sung, Suwon-city (KR); Jang-woo Lee, Suwon-city (KR); Dong-bin Lim, Suwon-city (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/804,051

(22) Filed: Mar. 19, 2004

(30) Foreign Application Priority Data
May 7, 2003 (KR) 2003-29091

(51) Int. Cl. A23L 1/00

(52) U.S. Cl. 99/348

(57) ABSTRACT

A bread maker including: upper and lower kneading drums holding upper and lower parts of a mixing bag whose side edges have upper opening parts and lower sealed parts, respectively; a driver rotating the kneading drums in clockwise and counterclockwise directions; a baking tray having a slit, is placed between the upper and lower kneading drums; an oven compartment between the baking tray and the upper kneading drum; and a controller which controls the driver, so that exposure of the opening parts of the mixing bag to the inside of the oven compartment is prevented. Hence, leaking granules of the raw materials contained in the mixing bag and malfunction of the bread maker can be prevented and the inside of the oven compartment can be kept clean.

### CROSS-REFERENCE TO RELATED APPLICATIONS

This application claims the benefit of Korean Patent Application No. 2003-029091, filed on May 7, 2003, in the Korean Intellectual Property Office, the disclosure of which is incorporated herein by reference.

### BACKGROUND OF THE INVENTION

1. Field of the Invention

An aspect of the present invention relates to a bread maker, more particularly to a bread maker which prevents granules of raw materials for bread from leaking out of a mixing bag in an oven compartment during a kneading process.

2. Description of the Related Art

Conventionally, various bread makers have been developed to allow a user to easily make bread by automatically performing multiple steps such as kneading, leavening and baking of raw materials to provide finished bread to the user.

Typically, a bread maker in which dough is kneaded by reciprocating a mixing bag up and down comprises an oven compartment; a pair of parallel kneading drums which are disposed in upper and lower parts of the oven compartment and rotated in clockwise and counterclockwise directions; a baking tray having a slit, is placed between the upper and lower kneading drums; a pair of dough-blocking members disposed in an upper part of the oven compartment between the baking tray and the upper kneading drum and prevents raw materials for bread in the mixing bag from being moved toward the upper kneading drum; a heater to heat the inside of the oven compartment; a rotation sense part to sense rotations of the upper and lower kneading drums; a driver to rotate the upper and lower kneading drums; and a controller to control rotations of the upper and lower kneading drums.

Upper and lower ends of the mixing bag containing raw materials for bread are wound by the pair of kneading drums and then the mixing bag is reciprocated for a predetermined period of time, so that dough is kneaded in the mixing bag.

Thereafter, only the lower kneading drum is rotated, and the kneaded dough in the mixing bag moves into the baking tray. Then, the heater heats the inside of the oven compartment, thereby making bread in the baking tray.

The dough in the mixing bag is kneaded in such a way that the mixing bag which is wound by the kneading drums rotated in clockwise and counterclockwise directions is moved up and down through the slit formed in the baking tray and the dough-blocking members.

In FIG. 6, opening parts 110 of the mixing bag 100 are formed in upper parts of the side edges of the mixing bag 100. Closed parts 120 of the mixing bag 100 are formed in lower parts of side edges of the mixing bag 100. However, during the kneading process, the mixing bag 100 moves up and down. The opening part 110 of the mixing bag 100 wound by the upper kneading drum 200 is moved down below a pair of dough-blocking members 500 when the mixing bag 100 moves down. Then, granules of the dough leak out of the mixing bag 100 through the opening part 110 of the mixing bag 100, when the mixing bag 100 moves back up in the oven compartment, thereby causing malfunction and making it hard to keep the inside of the oven compartment clean.

### SUMMARY OF THE INVENTION

Accordingly, it is an aspect of the present invention to provide a bread maker which is capable of preventing granules of raw materials for bread from leaking out of a mixing bag in an oven compartment during a kneading process.

Additional aspects and advantages of the invention will be set forth in part in the description which follows and, in part, will be obvious from the description, or may be learned by practice of the invention.

The foregoing and/or other aspects of the present invention are also achieved by providing a bread maker comprising upper and lower kneading drums holding upper and lower parts of a mixing bag whose side edges have an upper opening part and a lower sealed part, respectively; a driver rotating the upper and lower kneading drums in clockwise and counterclockwise directions; a baking tray having a slit, placed between the upper and lower kneading drums; an oven compartment between the baking tray and the upper kneading drum; and a controller which controls the driver, to prevent exposure of the opening part of the mixing bag to the inside of the oven compartment.

According to an aspect of the invention, the bread maker further comprises a rotation sensor sensing a rotation of the upper kneading drum, wherein the controller controls an operation of the driver based on a rotation signal of the upper kneading drum sensed by the rotation sensor.

According to another aspect of the invention, the distance between the upper and lower kneading drums is such that the exposure of the opening part of the mixing bag to the inside of the oven compartment can be prevented.

According to another aspect of the invention, a controller controls the rotation of the upper kneading drum when the mixing bag is wound by the upper kneading drum, to prevent the exposure of the opening part of the mixing bag to the inside of the oven compartment during a kneading process.

### BRIEF DESCRIPTION OF THE DRAWINGS

These together with other aspects and advantages of the invention will become apparent and more readily appreciated from the following description of the preferred embodiments, taken in conjunction with the accompanying drawings of which:

FIG. 1 is a perspective view of a bread maker according to an embodiment of the present invention;

FIG. 2 is an exploded perspective view of a driver of upper and lower kneading drums according to the present invention;

FIG. 3 is a block diagram of a driving sequence of the driver shown in FIG. 2;

FIG. 4 is a sectional view of upward and downward movement of a mixing bag according to the present invention;

FIG. 5 is a sectional view of a downward movement of the mixing bag according to the present invention;

FIG. 6 is a sectional view of the downward movement of the mixing bag of a conventional bread maker.

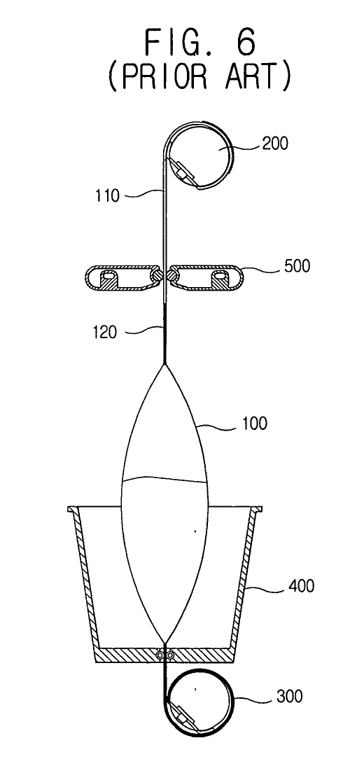

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout. The embodiments are described below in order to explain the present invention by referring to the figures.

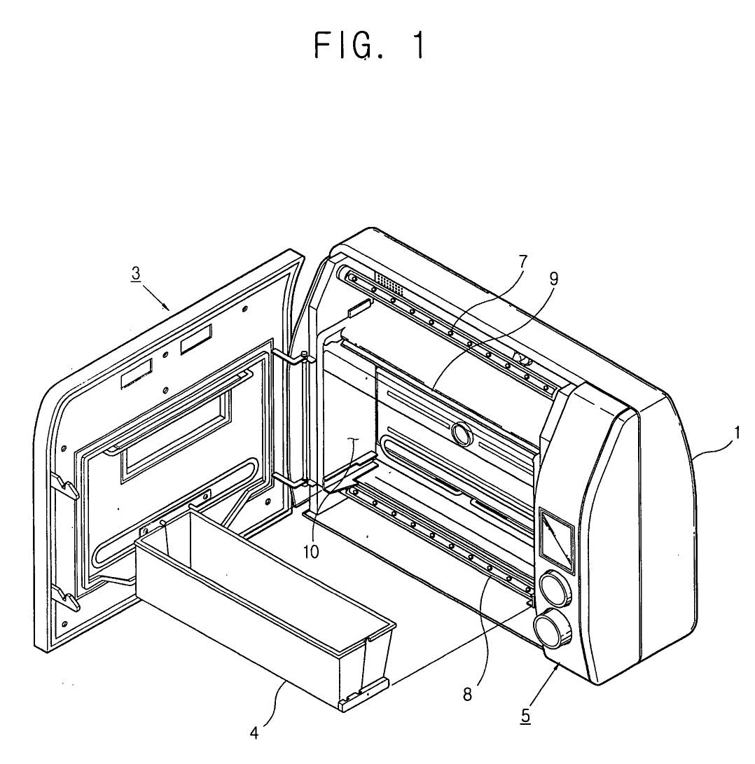

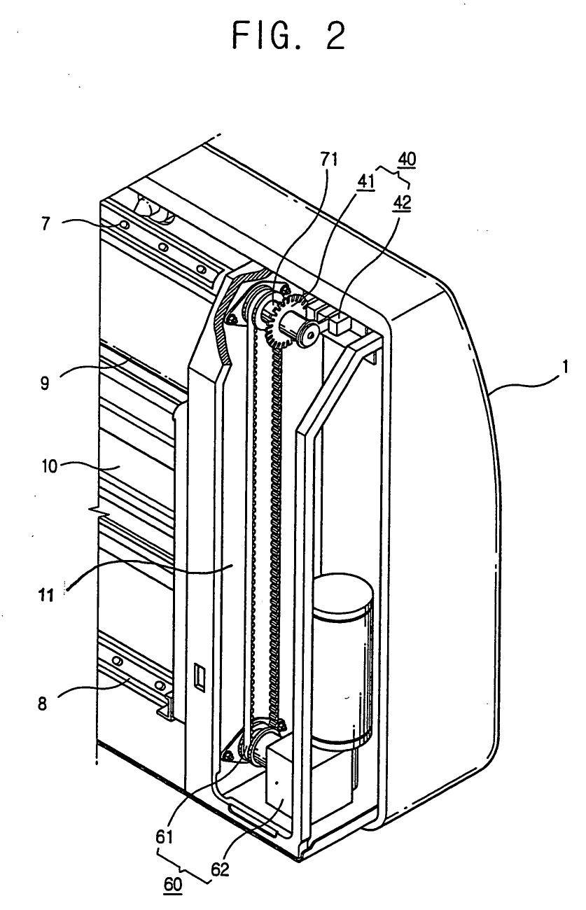

In FIGS. 1 and 2, a bread maker according to the present invention comprises a main body 1 provided with an oven compartment 10; a door 3 to rotatably open and close a front opening of the oven compartment 10; an operation display panel 5 on a front side of the main body 1 to display an operation state of the main body 1; and a driver 60 disposed in one side of the oven compartment to rotate the upper and lower kneading drums 7 and 8.

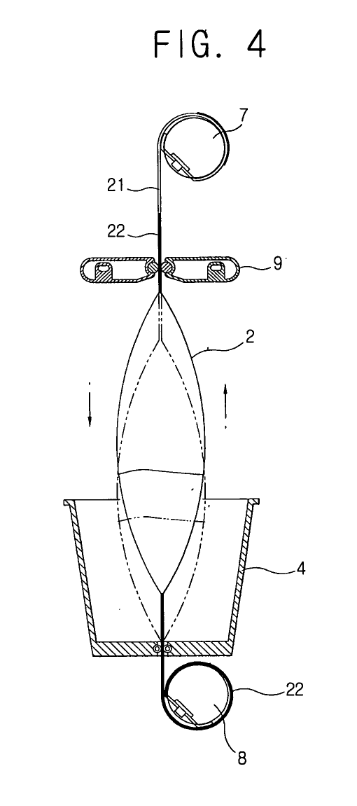

The upper and lower kneading drums 7 and 8 are disposed in parallel in the upper and lower parts inside of the oven compartment 10, to wind upper and lower ends of a mixing bag 2 filled with raw materials for bread in clockwise and counterclockwise directions as shown in FIG. 4. A pair of dough-blocking members 9 are placed between the upper and lower kneading drums 7 and 8 to prevent the raw materials kneaded in the mixing bag from moving toward the upper kneading drum 7. In a lower part of the oven compartment 10, a baking tray 4 which may be slid out of the oven compartment 10 and contains the kneaded materials for bread is provided between the upper and lower kneading drums 7 and 8.

The driver 60 comprises a driving motor 62 to rotate the lower kneading drum 8; and a driving belt 61 which connects the upper and lower kneading drums 7 and 8 to each other to rotate the upper and lower kneading drums 7 and 8.

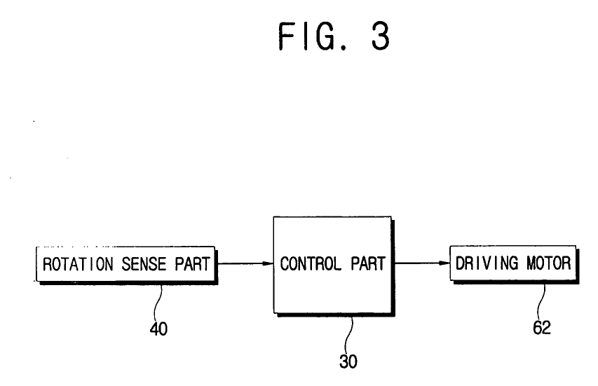

In FIGS. 2 and 3, the bread maker of the present invention further comprises a rotation sense part 40 to sense a rotational position of at least one of the upper and lower kneading drums 7 and 8; and a controller 30 to control an operation of the driver 60 based on the rotational position of the upper and lower kneading drums 7 and 8 sensed by the rotation sense part 40.

For the convenience of description, it is assumed that the rotation sense part 40 senses the rotational position of the upper kneading drum 7, by way of example. The rotation sense part 40 comprises a rotational signal transmitter 41 connected to a rotation shaft 71 of the upper kneading drum 7; and a rotation sensor 42 positioned adjacent to the rotational signal transmitter 41 in a component compartment 11 to sense a rotational motion of the rotational signal transmitter 41.

In FIGS. 2 and 3, information on the rotational position of the upper kneading drum 7 detected by the rotation sensor 42 of the rotation sense part 40 is transmitted to the controller 30. Based on this information, the controller 30 controls the wind of the mixing bag 2 and moves it up and down by controlling the operation of the driving motor 62 of the driver 60 rotating the upper and lower kneading drums 7 and 8 during the winding and kneading processes.

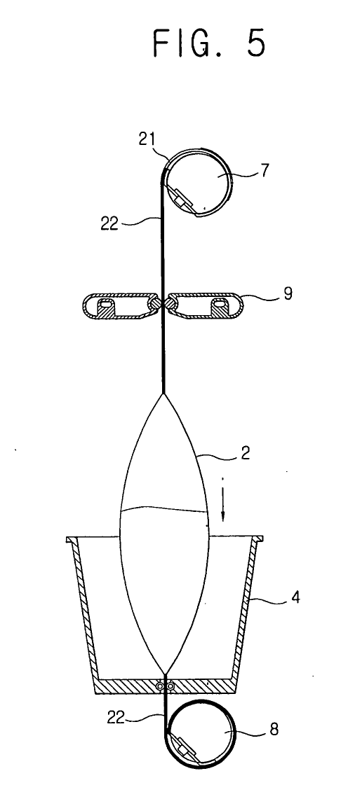

In FIGS. 4 and 5, the mixing bag 2 wound by the upper and lower kneading drums 7 and 8 moves up and down. When the mixing bag 2 moves down, the controller 30 controls the number of rotations of the upper kneading drum 7 so as to prevent the upper opening part 21 of the mixing bag 2 from being exposed to inside of the oven compartment 10 by controlling the operation of the driver 60 in response to the transmitted signal of the rotation sensor 42. Thus, the opening parts 21 of opposite side edges of the mixing bag 2 are not exposed to the inside of the oven compartment 10.

Further, if the distance between the upper and lower kneading drums 7 and 8 is relatively narrow as compared with the conventional bread maker, and the controller 30 controls the number of rotations of the upper kneading drum 7 by controlling the operation of the driver 60 when the mixing bag 2 is wound by the upper kneading drum 7, then the exposure of the opening part 21 to the inside of the oven compartment 10 can be prevented when the mixing bag 2 is moved down.

That is, if the distance between the upper and lower kneading drums 7 and 8 is made relatively narrow, as compared with the conventional bread maker, then the controller 30 controls the driver 60, so that the number of rotations of the upper kneading drum 7 increases in accordance with the decrease in the distance between the upper and lower kneading drums 7 and 8. Therefore, the opening part 21 of the mixing bag 2 can be prevented from being exposed to the inside of the oven compartment 10 upon the completion of the downward movement of the mixing bag 2, because the kneading process can still be done with the decrease in the number of rotations of the kneading drums 7 and 8.

When the mixing bag 2 is sufficiently lengthened, the lengthened portion becomes part of a closed part 22 of the mixing bag 2. Thereafter, when the mixing bag 2 is wound by the upper kneading drum 7, the number of rotations of the upper kneading drum 7 increases in accordance with the lengthened portion of the mixing bag 2 by controlling the driver 60. Then, although the upper and lower kneading drums 7 and 8 are rotated with the same number of rotations as in the conventional bread maker, the opening part 21 of the mixing bag 2 is prevented from being exposed to the inside of the oven compartment 10 upon the completion of the downward movement of the mixing bag 2, thus preventing granules of the raw materials from leaking out of the mixing bag and malfunctioning of the bread maker.

As described above, according to the present invention, the controller controls the driver, so that the opening part of the mixing bag is wound by the upper kneading drum, thus, preventing granules of the raw materials contained in the mixing bag from leaking out and malfunctioning of the bread maker can be prevented and the inside of the oven compartment can be kept clean.

Although a few embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A bread maker comprising:
upper and lower kneading drums holding upper and lower parts of a mixing bag whose side edges have upper opening parts and lower sealed parts, respectively;
a driver rotating the kneading drums in clockwise and counterclockwise directions;
a baking tray which is placed between the upper and lower kneading drums and formed with a slit;
and an oven compartment formed between the baking tray and the upper kneading drum; and
a controller which controls the driver, so that exposure of the opening parts of the mixing bag to the inside of the oven compartment is prevented.

2. The bread maker of claim 1, further comprising: a rotation sense part sensing a rotational position of one of the upper and lower kneading drums.

3. The bread maker of claim 1, wherein the distance between the upper and lower kneading drums is such that the exposure of the opening part of the mixing bag to the inside of the oven compartment can be prevented.

4. The bread maker of claim 2, wherein the distance between the upper and lower kneading drums is such that the exposure of the opening part of the mixing bag to the inside of the oven compartment can be prevented.

5. The bread maker of claim 1, wherein the controller controls a rotation of the upper kneading drum when the mixing bag is wound by the upper kneading drum, so that the exposure of the opening part of the mixing bag to the inside of the oven compartment can be prevented during a kneading process.

6. The bread maker according to claim 2, wherein a controller controls a rotation of the upper kneading drum when the mixing bag is wound by the upper kneading drum, so that the exposure of the opening part of the mixing bag to the inside of the oven compartment can be prevented during a kneading process.

7. The bread maker of claim 1, wherein the controller controls an operation of the driver based on a rotation signal of the upper kneading drum sensed by a rotation sensor.

8. A method of kneading bread in a bread maker, comprising:
rotating an upper kneading drum and a lower kneading drum in a first direction and a direction opposite the first direction;
detecting a rotational position of one of the upper kneading drum and the lower kneading drum;
transmitting information on a rotation signal detected by a rotation sensor to a controller; and
controlling a driver based on the rotation signal sensed by the rotation sensor.

9. The bread maker of claim 1, further comprising:
a pair of dough-blocking members disposed in an upper part of the oven compartment between the baking tray and the upper kneading drum.

10. The bread maker of claim 1, wherein the upper kneading drum and the lower kneading drum are at a predetermined distance from each other such that a number of rotations of the upper kneading drum increases.

11. The bread maker of claim 2, wherein the upper kneading drum and the lower kneading drum are at a predetermined distance from each other such that a number of rotations of the upper kneading drum increases.

12. The bread maker of claim 2, wherein the rotation sense part comprises:
a rotation signal transmitter connected to a rotation shaft of the upper kneading drum; and
a rotation sensor to sense a rotation of the rotational signal transmitter.

13. The bread maker of claim 5, wherein the controller controls an operation of the driver based on a rotation signal of the upper kneading drum sensed by the rotation sense part.

14. The bread maker according to claim 1, wherein the mixing bag is lengthened for the lengthened portion to become part of the closed part of the mixing bag.

15. The method of kneading bread in a bread maker according to claim 8, further comprising, adjusting a distance between the upper kneading drum and the lower kneading drums such that the exposure of the opening part of the mixing bag to the inside of the oven compartment can be prevented.

16. The method of kneading bread in a bread maker according to claim 8, wherein the upper kneading drum and the lower kneading drum are at a predetermined distance from each other such that a number of rotations of the upper kneading drum increases.
